(19) United States
(12) Patent Application Publication
(10) Pub. No.: US 2026/0367600 A1
(43) Pub. Date: Nov. 19, 2026

(54) Dynamic Class Partial Reconfiguration

(71) Applicant: Altera Corporation, San Jose, CA (US)

(72) Inventor: Richard Herveille, El Dorado Hills, CA (US)

(21) Appl. No.: 19/732,418

(22) Filed: Jul. 6, 2026

(51) Int. Cl. G05B 19/042

(52) U.S. Cl. CPC G05B 19/0423; G05B 2219/23077

(57) ABSTRACT

A data processing system may include processing circuitry and a non-transitory, computer-readable medium, including computer-readable instructions that, when executed by the processing circuitry, cause the processing circuitry to receive hardware description language (HDL) code that includes a definition of a base class and one or more definitions for one or more subclasses that extend the base class, where the base class specifies a partial reconfiguration interface for a partial reconfiguration region of a programmable logic device. The instructions also may cause the processing circuitry to parse the HDL code to identify a declaration of the base class and an assignment of a subclass definitions to the declared base class. The instructions may further cause the processing circuitry to generate a configuration for the programmable logic device that includes partial reconfiguration controller intellectual property (IP) configured to load a persona corresponding to the assigned subclass definition into the partial reconfiguration region.

### BACKGROUND

The present disclosure relates generally to integrated circuits and, more specifically, to partial reconfiguration for programmable logic devices.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Modern electronics, such as computers, portable devices, network routers, data centers, Internet-connected appliances, and the like, tend to include at least one integrated circuit device. Integrated circuit devices may take on a variety of forms, including processors, memory devices, and programmable logic devices, to name only a few examples. In cases where the integrated circuit device is a programmable logic device, such as field programmable gate array (FPGA), the programmable logic device may include a programmable fabric of logic that may be programmed and reprogrammed after manufacturing to provide a wide variety of functionality based on a system design. Because programmable logic devices may be reprogrammable, in some cases, it may be desirable to define partial reconfiguration regions or areas of the programmable fabric that may be dynamically reprogrammed with different logic functions while the remainder of the device continues to operate. However, implementing partial reconfiguration regions may be a source of timing and resource challenges.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device;

FIG. 2 is a block diagram of an example of the integrated circuit device of FIG. 1;

FIG. 3 is a flow diagram of the integrated circuit device programmed with different personas over time;

FIG. 4 is a Unified Modeling Language (UML) diagram depicting a module that instantiates a base class and multiple subclasses associated with different personas;

FIG. 5 is an example of Hardware Description Language (HDL) code defining and instantiating a base class and multiple subclasses;

FIG. 6 is a flowchart illustrating a method of implementing and compiling HDL that includes dynamic classes corresponding to personas to be implemented on a programmable logic device;

FIG. 7 is an example of a partial reconfiguration flow that utilizes dynamic classes to limit design partitioning and preparation while compiling HDL code; and

FIG. 8 is a block diagram of a data processing system that may incorporate the systems and methods of this disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

As mentioned, programmable logic devices may include a programmable fabric that a designer (e.g., anyone configuring, reconfiguring, or simulating the programmable logic device) may interact with to cause the programmable logic device to perform desired operations. In some cases, a designer may describe a system design for a programmable logic device using Register-Transfer Level (RTL) code. For example, the designer may provide a system design (e.g., a user design, a digital hardware design, a configuration, a circuit design) in a hardware description language (HDL). The system design may define an application to be implemented on the programmable logic device and/or an intended behavior of the programmable logic device. The designer may access a data processing system that includes design software to generate a configuration file for configuring the programmable logic device based on the system design. More specifically, the design software may compile the system design into the configuration file, which may be used to configure and/or reconfigure the programmable fabric of the programmable logic device. In some aspects, the compiler may synthesize and/or fit the system design onto the programmable logic device.

In some cases, a designer may designate one or more partial reconfiguration regions for the programmable logic device. As used herein a partial reconfiguration region refers to an area of programmable fabric that can be dynamically reprogrammed with different personas (i.e., different logic functions) while the remainder of the device continues to operate. Some systems may provide partial reconfiguration flows that may enable designers to define personas to be implemented in partial reconfiguration regions. However, as will be discussed throughout this disclosure, partial reconfiguration flows may demand significant timing resources. For example, in some systems, the partial reconfiguration flow may include design partitioning and preparation operations, such as planning the partial reconfiguration system by determining which portions of the design will be static and which will be dynamically reconfigurable. The design partitioning and preparation operations may then include identifying partial reconfiguration resources available on the programmable logic device. The design partitioning and preparation operations also may include coding the design by creating separate modules (e.g., hardware design containers that define and/or control partial reconfiguration region) for each persona. In some cases, the design partitioning and preparation operations may include simulating design to verify the functional behavior. The design partitioning and preparation operations also may include verifying timing to ensure the design meets timing requirements (e.g., verifying that signals propagate through the programmable logic device within required clock cycle constraints to ensure the design operates at the intended frequency). If timing is not met at any operation the data processing system may iterate on the preceding operation to adjust the design until timing requirements are satisfied. The design partitioning and preparation operations also may include partitioning static regions of the programmable logic device from the partial reconfiguration regions. In some cases, the design partitioning and preparation operations may include re-verifying timing after verifying partitions. After these design partitioning and preparation operations are complete, the partial reconfiguration flow may include a number of physical implementation operations. For example, the physical implementation operations may include assigning partial reconfiguration regions to particular areas of the programmable fabric, specifying place regions as exclusive, creating a routing region for each place region, specifying partitions as reconfigurable partitions, creating revisions and compiling the design for each revision, verifying timing for each revision, generating configuration files, and programming the device.

As will be appreciated, the preceding design partitioning and preparation operations may be time-consuming and resource-intensive. For example, the design partitioning and preparation operations may cause a designer to manually create separate modules for each persona, compile each module independently, and create special wrappers that instantiate dedicated multiplexers, bus functional models, and interfaces to coordinate the personas. Moreover, in some systems, only one persona can be tested or simulated at a time making it difficult to test reconfiguration from a first persona to a second persona. The complexity of the design partitioning and preparation operations may discourage designers from utilizing partial reconfiguration, even when partial reconfiguration would otherwise provide benefits. It is, thus, recognized that systems and methods that enable a designer to efficiently implement partial reconfiguration regions would improve compile-time efficiency and improve the ability of designers to generate and implement personas.

Aspects of the present disclosure address the preceding deficiencies in partial reconfiguration flow by leveraging HDL dynamic classes. Some HDLs, such as SystemVerilog, may enable designers to define logic in terms of classes. A class may encapsulate attributes (e.g., data, definitions) and methods (e.g., functions) that together describe a logic function to be implemented on a programmable logic device. In contrast to static logic that exists when the system starts, HDLs may include dynamic classes, which may be instantiated at runtime when the code instantiates or declares a class (e.g., calls a constructor to a class). In some systems, dynamic classes are used in simulation and verification. However, without aspects of the present disclosure, some systems may not support synthesizing dynamic classes. More specifically, some systems may not support synthesizing dynamic classes because calling dynamic classes (e.g., declaring dynamic classes, instantiating dynamic classes) asks the design software to create logic, which is not possible in traditional silicon (e.g., non-programmable logic devices). However, because programmable logic devices can be reprogrammed after manufacturing, it is now recognized that design software can leverage dynamic classes when implementing logic functions using partial reconfiguration.

With this in mind, the systems and methods described herein provide a simplified partial reconfiguration flow that handles design partitioning and preparation using dynamic classes. For example, according to aspects of the present disclosure, a designer may define a base class in HDL. In some aspects, the base class may specify common attributes and methods that are shared by all personas. For example, the base class may specify the boundaries and interface of the partial reconfiguration region and act as wrapper logic for the partial reconfiguration region. As used herein, the partial reconfiguration region refers to the physical area of the programmable fabric that is dynamically reprogrammed, while the partial reconfiguration interface (sometimes referred to as the interface boundary or bounding box) refers to the input and output ports that connect the partial reconfiguration region to the static portions of the programmable logic device. The designer also may define one or more subclasses corresponding to personas in the HDL. Subclasses may be any class that extends the base class. Each subclass may describe the logic function for a respective persona that can be implemented in the partial reconfiguration region. In some aspects, each subclass may include its own attributes and methods that define the particular logic function for that persona.

After defining base classes and corresponding subclasses in HDL, the designer may define a module. The module may specify the behavior or function of the programmable logic device, including any partial reconfiguration regions of the programmable logic device. In the module, the designer may instantiate a variable of the base class type. The designer also may assign a subclass to the base class variable to trigger reconfiguration of the partial reconfiguration region associated with the base class and implement the logic function of the subclass (e.g., based on the attributes and/or methods defined in the subclass). Contrary to previous systems that utilize separate modules for each persona, in the present disclosure, the base class and the one or more subclasses may be instantiated within a common module, enabling the design software to manage the partial reconfiguration regions and personas from a single design unit.

After the designer creates the HDL file, the designer may provide the HDL file to a data processing system that includes design software. The design software may receive the HDL and compile the HDL (e.g., to implement the behaviors or functions described in the HDL on a programmable logic device, to configure and/or reconfigure the programmable logic device). For example, the design software may parse the HDL and identify (e.g., detect) a definition for a base class in the HDL. In response to identifying the definition for the base class, the design software may recognize the base class as defining a potential partial reconfiguration region with the base class interface as a bounding box. The base class interface may refer to a partial reconfiguration interface that the base class contains as a common attribute, which defines the input and output ports for the partial reconfiguration region. The design software also may identify a subclass definition that extends the base class and generate a corresponding virtual persona for the subclass. In some aspects, after the design software identifies respective base class and subclass definitions, the design software may continue to parse the HDL to identify class declarations. For example, the design software also may detect a base class variable declaration (e.g., instantiation of the base class type) in a module and create a virtual partial reconfiguration region assigned to that variable. In some cases, the design software may detect a subclass assignment to the base class variable. In response, the design software may trigger reconfiguration of the partial reconfiguration region to implement the logic function of the subclass.

In some aspects, design software compiling the HDL may automatically instantiate partial reconfiguration controller intellectual property (IP) to manage the reconfiguration process (e.g., controlling interface ports, pausing inputs to the partial reconfiguration region). The partial reconfiguration controller IP may be a hardware block that, at runtime, manages the actual process of swapping personas on the programmable logic device, including invoking a freeze method to pause outputs before reconfiguration begins, loading the new persona into the partial reconfiguration region, and releasing the freeze after the new persona is loaded. For example, if a first subclass is initially assigned to the base class variable, and the base class variable is subsequently assigned to a second subclass, the partial reconfiguration controller IP may freeze outputs to static regions of the programmable logic device during the reconfiguration and/or facilitate the reconfiguration of the partial reconfiguration region to implement the persona associated with the second subclass.

As will be discussed throughout this disclosure, the systems and methods described herein may provide several benefits related to partial reconfiguration. For example, aspects of the present disclosure may enable a designer to partition designs in HDL rather than manually partitioning designs by defining independent modules and wrappers to coordinate the independent modules. Moreover, aspects of the present disclosure may automatically map personas to a partial reconfiguration region instead of demanding that a designer manually map each persona to a particular region. In some aspects, partial reconfiguration controller IP may manage the reconfiguration process, including freezing outputs during reconfiguration and loading the appropriate persona into the partial reconfiguration region. For example, aspects of the present disclosure may enable simulations of dynamic persona switching without special wrappers or testbenches (e.g., supplemental code that verifies the persona's output and/or behavior during simulation). Instead, the HDL language natively handles such functionality, as dynamic classes are inherently supported by HDL simulators. In at least these ways, the systems and methods described herein may include an improved partial reconfiguration flow that may be easier for designers to use and decrease the resources (e.g., timing resources) associated with compiling system designs and implementing partial reconfiguration regions in programmable logic devices.

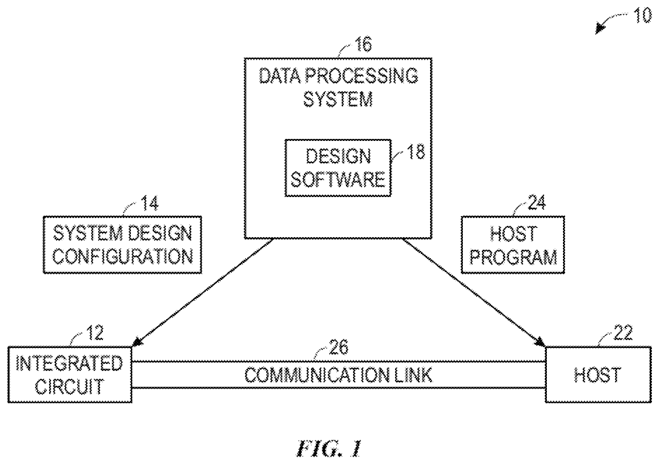

With this in mind, FIG. 1 illustrates a block diagram of a system 10 that may be used to program an integrated circuit device 12, such as an FPGA (e.g., Agilex™, Stratix®, Arria®, MAX®, or Cyclone® devices by Altera® Corporation), with such a system design using a system design configuration 14. In other examples, the integrated circuit device 12 may be any suitable programmable logic device that is manufactured to have a particular system design with circuitry to perform desired data processing operations. The integrated circuit device 12 may be a single monolithic integrated circuit or a multi-die system of integrated circuits. The integrated circuit device 12 may include a single integrated circuit, multiple integrated circuits in a package, or multiple integrated circuits in multiple packages communicating remotely (e.g., via wires, via traces) and may be referred to as an integrated circuit device or an integrated circuit system whether formed from a single integrated circuit or multiple integrated circuits in a package.

A designer may desire to implement the system design 14 (sometimes referred to as a circuit design or configuration) to perform a wide variety of possible operations on the integrated circuit device 12. In some cases, the designer may specify a high-level program to be implemented, such as an OPENCL® program that may enable the designer to more efficiently and easily provide programming instructions to configure a set of programmable logic cells for the integrated circuit device 12 without specific knowledge of low-level hardware description languages (e.g., SystemVerilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

In a configuration mode of the integrated circuit device 12, a designer may use a data processing system 16 (e.g., a computer including a data processing system having a processor and memory or storage) to implement high-level designs (e.g., a system user design) using design software 18 (e.g., executable instructions stored in a tangible, non-transitory, computer-readable medium such as the memory or storage of the data processing system 16), such as a version of Altera® Quartus® by Altera Corporation. The data processing system 16 may use the design software 18 and a compiler 20 to convert the high-level program into a lower-level description (e.g., a configuration program, a bitstream) as the system design configuration 14. The compiler 20 may provide machine-readable instructions representative of the high-level program to a host 22 and the system design configuration 14 to the integrated circuit device 12. As will be discussed in more detail below, the system design configuration 14 may include an application program that may be associated with one or more functions. In particular, the application program may be configured to run the one or more functions on the data processing system 16. For example, the data processing system 16 may execute the application program.

Additionally or alternatively, the host 22 running the host program 24 may control or implement the system design configuration 14 onto the integrated circuit device 12. For example, the host 22 may communicate instructions from the host program 24 to the integrated circuit device 12 via a communications link 26 that may include, for example, direct memory access (DMA) communications or peripheral component interconnect express (PCIe) communications. The designer may use the design software 18 to generate and/or to specify a low-level program, using low-level tools such as the low-level hardware description languages described above. Further, in some embodiments, the system 10 may be implemented without a separate host 22 or host program 24. Thus, embodiments described herein are intended to be illustrative and not limiting.

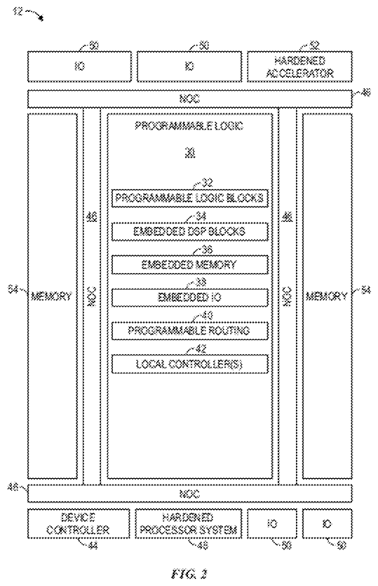

The integrated circuit device 12 may take any suitable form that may implement the system design configuration 14. In one example shown in FIG. 2, the integrated circuit device 12 may include programmable logic circuitry 30, which may include a two-dimensional array of many different functional blocks, such as programmable logic blocks 32, embedded digital signal processing (DSP) blocks 34, embedded memory blocks 36, and embedded input-output blocks 38. In many cases, there may be rows or columns of these functional blocks that may be programmably connected to one another using programmable routing 40. In some aspects, as will be described below, a portion of the programmable logic circuitry 30 may be dedicated as a partial reconfiguration region.

The programmable logic blocks 32 may be programmed to implement a wide variety of logic circuitry. The programmable logic blocks 32 may include a number of adaptive logic modules (ALMs), which may take the form of lookup tables (LUTs) that can be programmed to implement a logic truth table, effectively enabling any of the programmable logic blocks 32 to implement any desired logic circuitry when configured with the system design configuration 14. The programmable logic blocks 32 and are sometimes referred to as logic array blocks (LABs) or configurable logic blocks (CLBs).

The embedded DSP blocks 34, embedded memory blocks 36, and embedded IO blocks 38 may be distributed around the programmable logic blocks 32. For example, there may be several columns of programmable logic blocks 32 for every column of DSP blocks 34, column of embedded memory blocks 36, or column of embedded IO blocks 38. The embedded DSP blocks 34 may include “hardened” circuits that are specialized to efficiently perform certain arithmetic operations. This is in contrast to “soft logic” circuits that may be programmed into the programmable logic blocks 32 to perform the same functions, but which may not be as efficient as the hardened circuits of the DSP blocks 34. The embedded memory blocks 36 may include dedicated local memory (e.g., blocks of 20 kB, blocks of 1 MB). The embedded IO blocks 38 may allow for inter-die or inter-package communication. The embedded DSP blocks 34, embedded memory blocks 36, and embedded IO blocks 38 may be accessible to the programmable logic blocks 32 using the programmable routing 40.

The various functional blocks of the programmable logic circuitry 30 may be grouped into programmable regions, sometimes referred to as logic sectors, that may be individually managed and configured by corresponding local controllers 42 (e.g., sometimes referred to as Local Sector Managers (LSMs)). The grouping of the programmable logic circuitry 30 resources on the integrated circuit device 12 into logic sectors, logic array blocks, logic elements, or adaptive logic modules is merely illustrative. In general, the integrated circuit device 12 may include functional logic blocks of any suitable size and type, which may be organized in accordance with any suitable logic resource hierarchy. Indeed, there may be other functional blocks (e.g., other embedded blocks) than those shown in FIG. 2.

Before continuing, it may be noted that the programmable logic circuitry 30 of the integrated circuit device 12 may be controlled by programmable memory elements sometimes referred to as configuration random access memory (CRAM). Memory elements may be loaded with configuration data (also called programming data or a configuration bitstream) that represents the system design configuration 14. Once loaded, the memory elements may provide a corresponding static control signal that controls the operation of an associated functional block. In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, and the like. The configuration memory elements may use any suitable volatile and/or non-volatile memory structures such as random-access-memory (RAM) cells, fuses, antifuses, programmable read-only-memory (ROM) memory cells, mask-programmed, laser-programmed structures, or combinations of structures such as these.

A device controller 44, sometimes referred to as a secure device manager (SDM), may manage the operation of the integrated circuit device 12. The device controller 44 may include any suitable logic circuitry to control and/or program the programmable logic circuitry 30 or other elements of the integrated circuit device 12. For example, the device controller 44 may include a processor (e.g., an x86 processor or a reduced instruction set computer (RISC) processor, such as an Advanced RISC Machine (ARM) processor or a RISC-V processor) that executes instructions stored on any suitable tangible, non-transitory, machine-readable media (e.g., memory or storage). Additionally, or alternatively, the device controller 44 may include a hardware finite state machine (FSM). The device controller 44 may provide other functions, such as serving as a platform for virtual machines that may manage the operation of the integrated circuit device 12.

A network-on-chip (NOC) 46 may connect the various elements of the integrated circuit device 12. The NOC 46 may provide rapid, packetized communication to and from the programmable logic circuitry 30 and other blocks, such as a hardened processor system 48, high-speed input-output (IO) blocks 50, a hardened accelerator 52, and local device memory 54. The integrated circuit device 12 may include the hardened processor system 48 when the integrated circuit device 12 takes the form of a system-on-chip (SOC). The hardened processor system 48 may include a hardened processor (e.g., an x86 processor or a reduced instruction set computer (RISC) processor, such as an Advanced RISC Machine (ARM) processor or a RISC-V processor) that may act as a host machine on the integrated circuit device 12. The high-speed IO blocks 50 may enable communication using any suitable communication protocol(s) with other devices outside of the integrated circuit device 12, such as a separate memory device. The hardened accelerator 52 may include any hardened application-specific integrated circuitry (ASIC) logic to perform a desired acceleration function. For example, the hardened accelerator 52 may include hardened circuitry to perform cryptographic or media encoding or decoding. The memory 54 may provide local device memory (e.g., cache) that may be readily accessible by the programmable logic circuitry 30.

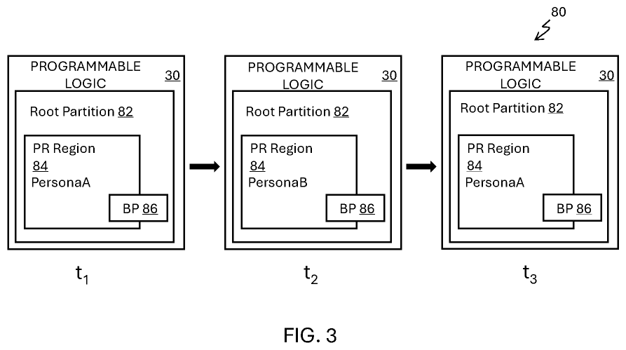

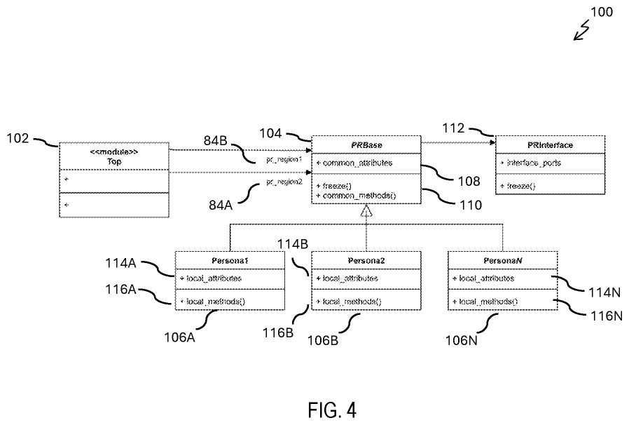

In some aspects, the integrated circuit device 12 may be used to implement a number of different partial reconfiguration personas during runtime. FIG. 3 illustrates an example of a runtime sequence 80 in which the programmable logic circuitry 30 is programmed to run different partial reconfiguration personas (e.g., subclasses as will be described in more detail with reference to FIG. 4) at different times t₁, t₂, and t₃. The programmable logic circuitry 30 has a static region referred to as a root partition 82 that encapsulates a partial reconfiguration region 84. Input and output boundary ports 86 connect the root partition 82 to the partial reconfiguration region 84. At various times (e.g., as defined in an HDL module and/or as controlled by the host 22 of FIG. 1 or the device controller 44 or hardened system processor 48 of FIG. 2), the partial reconfiguration region 84 is reprogrammed with a different partial reconfiguration persona. At time t₁, the partial reconfiguration region 84 is programmed with a first persona (PersonaA); at time t₂, the partial reconfiguration region 84 is programmed with a second persona (PersonaB); and at time t₃, the partial reconfiguration region 84 is once again programmed with the first persona (PersonaA). The root partition 82 provides a framework to support the personas that are programmed into the partial reconfiguration region 84, and thus the root partition 82 may remain static while the partial reconfiguration region 84 is reprogrammed with different personas.

With the preceding in mind, FIG. 4 is a Unified Modeling Language (UML) diagram 100 depicting a module 102 that instantiates a base class 104 and multiple subclasses 106A (PersonaA), 106B (PersonaB), 106N (PersonaN) (collectively the subclasses 106). As mentioned above the module 102 may instantiate (e.g., declare) the base class 104 and the subclasses 106 in an HDL, such as SystemVerilog. The base class 104 defines one or more base class attributes 108 and one or more base class methods 110. For example, the base class 104 may contain a reference to a partial reconfiguration interface 112 (e.g., as a base class attribute 108). The partial reconfiguration interface 112 defines the bounding box for the partial reconfiguration regions 84A, 84B associated with the base class 104. In some aspects, the partial reconfiguration regions 84A, 84B may represent multiple instantiations of the same base class 104 (e.g., multiple variables of the base class type declared in the module 102) or may be associated with different base classes. In some aspects, the partial reconfiguration interface 112 may include interface ports (e.g., the boundary ports 86 of FIG. 3) that are shared by all personas (e.g., subclasses 106 that extend the base class). For example, if one subclass 106A uses a clock, three inputs, and two outputs, and another subclass 106B uses a clock, one input, and one output, the partial reconfiguration interface 112 may include ports to accommodate both personas. In some aspects, the partial reconfiguration interface 112 may include a freeze method (e.g., as a base class method 110) that drives interface outputs to a known value (e.g., a predefined value) during reconfiguration to prevent undefined behavior that may occur during reconfiguration from affecting static logic in the programmable logic device (e.g., the integrated circuit device 12). Additionally or alternatively, in some aspects, the partial reconfiguration interface 112 may connect (e.g., couple) the partial reconfiguration region to a static root partition, as described with reference to the boundary ports 86 of FIG. 3.

As mentioned, the base class attributes 108 may refer to common attributes shared by all subclasses 106, such as interface definitions or configuration parameters. As an example, a base class attribute 108 may include interface ports or a reference to the partial reconfiguration interface 112. Likewise, the base class methods 110 may refer to common methods shared by all subclasses 106 (e.g., all personas). As an example, a base class method 110 may include a freeze method that drives interface outputs to a known value during reconfiguration. In some cases, the base class methods 110 may include common methods that provide shared functionality across all subclasses. In some aspects, each subclass 106 may include its own local attributes 114A, 114B, 114C and local methods 116A, 116B, 116C that define the particular logic function for that persona. For example, the subclass 106A (PersonaA) may include local attributes 114A defining encryption keys and local methods 116A implementing an encryption algorithm. Conversely, the second subclass 106B (PersonaB) may include local attributes 114B defining compression parameters and local methods 116B implementing a data compression function. As another example, the subclass 106N (PersonaN) may include local attributes 114N defining video encoding settings and local methods 116N implementing a video encoding function. However, these are just examples, as will be appreciated a designer may define any number of subclasses 106 with any suitable local attributes and local methods.

Although not depicted in this example, in some aspects, multiple layers of subclasses may be implemented. For example, a first subclass may extend the base class, and a second subclass may extend the first subclass, creating multiple levels of inheritance. In some aspects, the base class 104 may be an intermediate class. However, at some point in the hierarchy, a super class (e.g., a highest level base class) will define the interface that sets the bounding box for the partial reconfiguration region. This multilevel hierarchy allows for more flexible organization of personas (e.g., based on common attributes and/or common methods) while maintaining the shared interface.

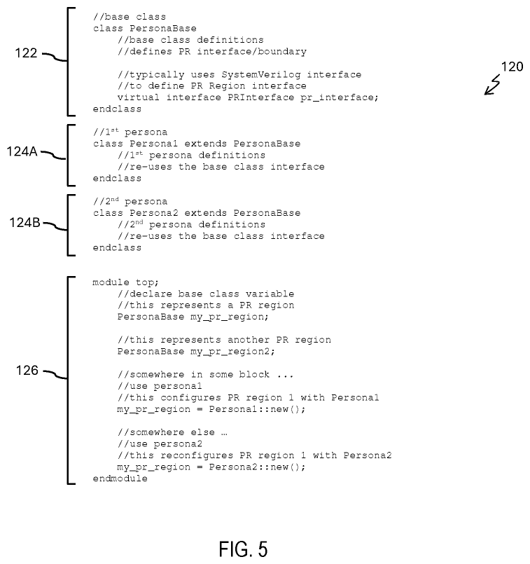

Turning now to an example of HDL code with dynamically reconfigurable classes, FIG. 5 is an example of HDL code defining and instantiating a base class and multiple subclasses. More specifically, FIG. 5 is an example of SystemVerilog 120 pseudocode that illustrates dynamically reconfigurable subclasses. The SystemVerilog 120 begins with a base class definition 122 that defines a PersonaBase class (e.g., corresponding to the base class 104 of FIG. 4). The base class definition 122 may specify the partial reconfiguration interface boundary. In some aspects, the base class definition 122 may include a virtual interface (e.g., PRInterface pr_interface) that defines the partial reconfiguration region interface (e.g., the partial reconfiguration interface 112 of FIG. 4). In some aspects, the base class definition 122 provides the common attributes and methods that will be shared by all subclasses (personas) that extend the base class.

The SystemVerilog 120 also includes a first subclass definition 124A and a second subclass definition 124B. The first subclass definition 124A and the second subclass definition 124B may correspond to the subclasses 106A (PersonaA) and 106B (PersonaB) of FIG. 4, respectively. Each subclass definition 124A, 124B extends the base class defined in the base class definition 122. As a result, each subclass 124A, 124B may inherit the common attributes and methods of the base class, including the partial reconfiguration interface boundary. In some aspects, each subclass definition 124A, 124B may include its own local attributes and local methods that define the particular logic function for that persona. For example, the first subclass definition 124A may include local attributes and local methods implementing a first logic function (e.g., an encryption algorithm), while the second subclass definition 124B may include local attributes and local methods implementing a second logic function (e.g., a data compression function).

The SystemVerilog 120 also includes a module 126. The module 126 may correspond to the module 102 of FIG. 4. The module 126 instantiates (e.g., declares) the base class (e.g., PersonaBase my_pr_region) representing the partial reconfiguration region defined in the base class definition 122. Within the module 126, the designer also may assign subclasses to the base class variable to configure or reconfigure the partial reconfiguration region. For example, the module 126 may include an assignment (e.g., my_pr_region=Persona1::new()) to configure the partial reconfiguration region based on the first subclass definition 124A. The module 126 may subsequently include an additional assignment (e.g., my_pr_region=Persona2::new()) to reconfigure the partial reconfiguration region based on the second subclass definition 124B. As an example, the assignments provided in this example may correspond to the runtime sequence 80 described with reference to FIG. 3, where the partial reconfiguration region 84 is programmed with PersonaA at time t₁ and reprogrammed with PersonaB at time t₂.

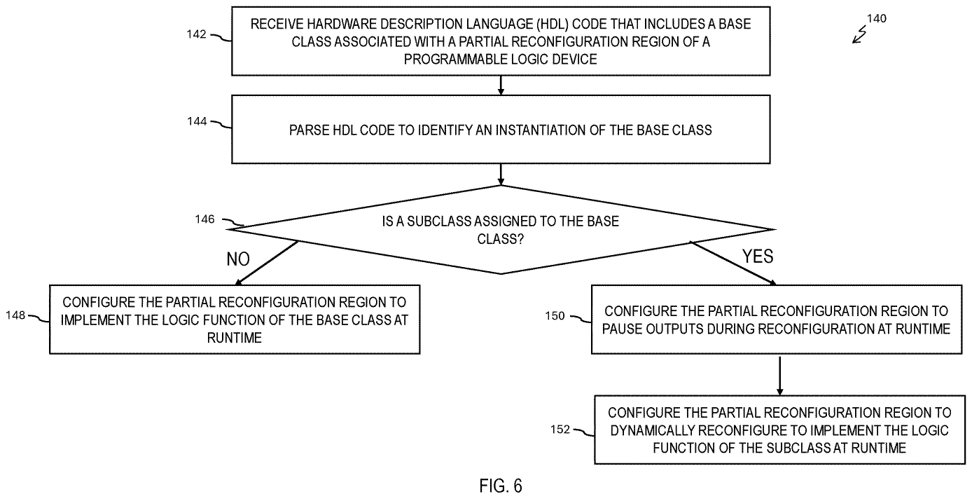

With this in mind, FIG. 6 is a flowchart illustrating a method 140 of implementing and compiling HDL that includes dynamic classes for different personas. More specifically, the method 140 describes how the data processing system 16 (e.g., the design software 18) processes HDL code during compilation to set up partial reconfiguration infrastructure that will operate at runtime. Although the following description of the method 140 is described as being performed by the data processing system 16 of FIG. 1, any suitable computing device (e.g., any device having a processor and memory) may perform the operations (e.g., blocks) described herein. Although the method 140 is described in a particular order, it should be understood that the method 140 may be performed in any suitable order and may exclude one or more of the blocks described herein.

At block 142, the data processing system 16 may receive hardware description language (HDL) code that includes a base class associated with a partial reconfiguration region of a programmable logic device. In some aspects, the designer may provide the HDL code to the data processing system 16 to compile the HDL code, simulate the HDL code, and/or generate a configuration (e.g., a configuration file, a configuration bitstream) based on the HDL code. As described above, the HDL code may include a base class definition (e.g., the base class definition 122 of FIG. 5) that specifies the boundaries and interface of the partial reconfiguration region.

At block 144, the data processing system 16 may parse the HDL code to identify an instantiation of the base class. For example, the data processing system 16 may detect a base class variable declaration (e.g., PersonaBase my_pr_region) in a module (e.g., the module 126 of FIG. 5) and create a virtual partial reconfiguration region assigned to that base class variable. The virtual partial reconfiguration region may refer to a representation of a partial reconfiguration region maintained by the data processing system 16 (e.g., the design software 18 during compilation) prior to the partial reconfiguration region being mapped to a physical area of the programmable logic circuitry 30 of the programmable logic device.

At decision block 146, the data processing system 16 may determine whether a subclass is assigned to the base class. For example, the data processing system 16 may parse the HDL code to identify whether a subclass assignment to the base class variable is present (e.g., my_pr_region=Persona1::new() in the module 126 of FIG. 5). During compilation, the data processing system 16 may identify such subclass assignments and configure the partial reconfiguration infrastructure accordingly. If a subclass is not assigned to the base class, the method 140 may proceed to block 148.

At block 148, the data processing system 16 may configure the partial reconfiguration region to implement the logic function (e.g., default logic) of the base class at runtime. For example, if no subclass assignment is detected in the HDL code (e.g., no assignment is present in the module 126 of FIG. 5), the data processing system 16 may configure the partial reconfiguration region to implement the common attributes and methods of the base class that are shared by all personas. As mentioned, in some aspects, the data processing system 16 may instantiate partial reconfiguration controller IP as it compiles the HDL file. The partial reconfiguration controller IP may be programmed into the programmable logic device (e.g., as a hardware block) and may manage the runtime behavior of the partial reconfiguration region. For example, if the data processing system 16 does not identify a subclass assigned to the base class in the HDL, the data processing system 16 may program the partial reconfiguration controller IP to load the default logic function of the base class into the partial reconfiguration region at runtime.

Conversely, if a subclass is assigned to the base class, at block 150, the data processing system 16 may configure the partial reconfiguration region to pause outputs when reconfiguration is triggered at runtime. For example, the base class and/or the partial reconfiguration interface (e.g., the partial reconfiguration interface 112 of FIG. 4) may define a freeze method (e.g., as a base class method 110 of FIG. 4). The freeze method may pause outputs of the partial reconfiguration region and/or override all interface outputs to a known value (e.g., a logic low, a logic high, a predefined safe state) to prevent undefined behavior from affecting static logic during reconfiguration. Because the freeze method is defined in the base class or the partial reconfiguration interface, the data processing system 16 may automatically invoke the freeze method during reconfiguration without requiring the designer to manually handle reconfiguration conditions, such as defining wrapper logic or instantiating dedicated multiplexers to tie off outputs. As mentioned, the freeze method is set up during compilation but invoked at runtime when reconfiguration occurs. For example, the partial reconfiguration controller IP may invoke the freeze method to pause outputs from the partial reconfiguration region before reconfiguration begins.

At block 152, the data processing system 16 may configure the partial reconfiguration region such that the partial reconfiguration region can dynamically implement the logic function of the subclass at runtime. For example, if the data processing system 16 detects the assignment of the first subclass 124A to the base class 122 in the module 126 of FIG. 5 (e.g., my_pr_region=Persona1::new()), the data processing system 16 may program the partial reconfiguration controller IP to implement the logic function defined by the first subclass definition 124A (e.g., an encryption algorithm). At runtime, the partial reconfiguration controller IP may load the new persona into the partial reconfiguration region and release the freeze after the new persona is loaded. If the data processing system 16 subsequently detects the assignment of the second subclass 124B to the base class 122 (e.g., my_pr_region=Persona2::new()), the data processing system 16 may configure the partial reconfiguration region such that, at runtime, the partial reconfiguration controller IP loads the partial reconfiguration region to implement the logic function defined by the second subclass definition 124B (e.g., a data compression function). As described with reference to FIG. 3, this reconfiguration may correspond to the runtime sequence 80 in which the partial reconfiguration region 84 transitions from PersonaA at time t₁ to PersonaB at time t₂.

In some aspects, the data processing system 16 may perform error handling as it parses and/or compiles the HDL file. For example, if the data processing system 16 detects a subclass definition that extends an undefined base class, the data processing system 16 may generate an error. Likewise, if the data processing system 16 detects a class variable declaration for a class that has not been defined, the data processing system 16 may generate an error. Similarly, if the data processing system 16 detects a subclass assignment to a base class variable where the subclass has not been declared, the data processing system 16 may default to the base class logic and/or generate an error. In at least these ways, the data processing system may handle improperly defined classes before configuring the programmable logic device, which may limit a risk of unintended runtime errors.

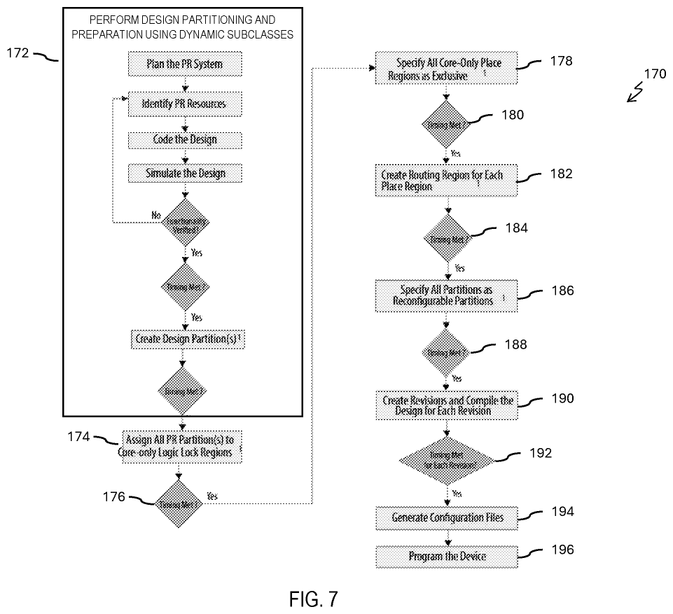

Turning to another benefit of the present disclosure, FIG. 7 is an example of a partial reconfiguration flow 170 that utilizes dynamic classes to limit the design partitioning and preparation operations while compiling HDL code. Although the following description of the partial reconfiguration flow 170 is described as being performed by the data processing system 16 of FIG. 1, any suitable computing device (e.g., any device having a processor and memory) may perform the operations (e.g., blocks) described herein. Although the partial reconfiguration flow 170 is described in a particular order, it should be understood that the partial reconfiguration flow 170 may be performed in any suitable order and may exclude one or more of the blocks described herein.

At block 172, the data processing system 16 may perform design partitioning and preparation operations using dynamic subclasses. As described above, the design partitioning and preparation operations may include planning the partial reconfiguration system, identifying partial reconfiguration resources, coding the design, simulating the design, verifying functionality, checking timing, creating design partitions, and rechecking timing. The dynamic class structure described herein may replace each of these manual operations. For example, the designer may plan the partial reconfiguration system by defining a base class that specifies the partial reconfiguration region boundaries and interface, rather than manually determining which portions of the design will be static and which will be dynamically reconfigurable. The base class and subclass definitions may inherently identify the partial reconfiguration resources by defining the interface and the personas that will use the partial reconfiguration region. The designer may code the design by defining subclasses that extend the base class, each describing a persona's logic function, rather than creating separate modules for each persona and manually managing them (e.g., using dedicated wrappers). In some aspects, the designer may simulate the design using dynamic classes, which are constructs already supported by HDL simulators, enabling the designer to simulate switching personas dynamically without special wrappers or testbenches. The design software may automatically create design partitions based on the base class and subclass definitions, rather than requiring the designer to manually separate static regions from reconfigurable regions.

After block 172, the data processing system 16 may proceed to the physical implementation operations (block 174-196). For example, at block 174, the data processing system 16 may assign all partial reconfiguration partitions to core-only logic lock regions (e.g., physical areas of the programmable logic circuitry 30 reserved for partial reconfiguration logic) on the programmable logic device. At block 176, the data processing system 16 may determine whether timing is met. At block 178, the data processing system 16 may specify all core-only place regions as exclusive (e.g., ensuring that only the assigned partition's logic can be placed within the reserved area, preventing static design logic from occupying the same area). At block 180, the data processing system 16 may determine whether timing is met.

At block 182, the data processing system 16 may create a routing region for each placed region (e.g., allocating routing resources such as interconnect wires and switches for each reserved area to prevent reconfiguration of one region from disrupting routing for the static design). At block 184, the data processing system 16 may determine whether timing is met. At block 186, the data processing system 16 may specify all partitions as reconfigurable partitions. At block 188, the data processing system 16 may determine whether timing is met. At block 190, the data processing system 16 may create revisions and compile the design for each revision. At block 192, the data processing system 16 may determine whether timing is met for each revision.

At block 194, the data processing system 16 may generate configurations (e.g., configuration bit streams, configuration files) for programming the programmable logic device. Because the data processing system 16 automatically instantiated the partial reconfiguration controller IP and mapped the dynamic class constructs to partial reconfiguration regions during compilation, the configuration files may include the partial reconfiguration controller IP, configuration data for each persona (e.g., the logic functions defined by each subclass), and the freeze logic for managing reconfiguration at runtime. At block 196, the data processing system 16 may program the programmable logic device based on the configuration. Once programmed, the programmable logic device may dynamically swap personas in the partial reconfiguration region at runtime based on the subclass assignments defined in the HDL. For example, the partial reconfiguration controller IP programmed onto the device may manage the runtime reconfiguration by invoking the freeze method, loading the persona corresponding to the assigned subclass into the partial reconfiguration region, and releasing the freeze to resume operation with the new persona.

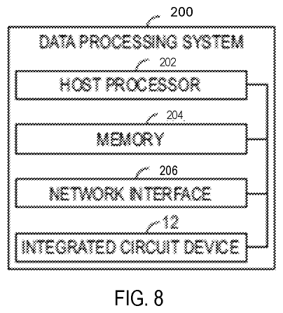

With the preceding in mind, the integrated circuit device 12 discussed above may be a component included in a data processing system, such as a data processing system 200, shown in FIG. 8. The data processing system 200 may include the integrated circuit device 12 (e.g., the programmable logic device after it has been configured and/or reconfigured to include a partial reconfiguration region), a host processor 202, memory and/or storage circuitry 204, and a network interface 206. The data processing system 200 may include more or fewer components (e.g., electronic display, user interface structures, application specific integrated circuits (ASICs)). The host processor 202 may include any of the foregoing processors that may manage a data processing request for the data processing system 200 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 204 may include random access memory (RAM), read-only memory (ROM), one or more hard drives, flash memory, or the like. The memory and/or storage circuitry 204 may hold data to be processed by the data processing system 200. In some cases, the memory and/or storage circuitry 204 may also store configuration programs (e.g., bitstreams) for programming the integrated circuit device 12. The network interface 206 may allow the data processing system 200 to communicate with other electronic devices. The data processing system 200 may include several different packages or may be contained within a single package on a single package substrate. For example, components of the data processing system 200 may be located on several different packages at one location (e.g., a data center) or multiple locations. For instance, components of the data processing system 200 may be located in separate geographic locations or areas, such as cities, states, or countries.

The data processing system 200 may be part of a data center that processes a variety of different requests. For instance, the data processing system 200 may receive a data processing request via the network interface 206 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. To provide only a few examples, these may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. A data processing system comprising:
processing circuitry; and
a non-transitory, computer-readable medium, comprising computer-readable instructions that, when executed by the processing circuitry, cause the processing circuitry to:
receive hardware description language (HDL) code comprising a definition of a base class and one or more definitions for one or more subclasses that extend the base class, wherein the base class specifies a partial reconfiguration interface for a partial reconfiguration region of a programmable logic device;
parse the HDL code to identify a declaration of the base class and an assignment of a subclass definition to the declared base class; and
generate a configuration for the programmable logic device, wherein the configuration comprises partial reconfiguration controller intellectual property (IP) configured to load a persona corresponding to the assigned subclass definition into the partial reconfiguration region.
EXAMPLE EMBODIMENT 2. The data processing system of example embodiment 1, wherein the partial reconfiguration controller IP is configured to load a first persona into the partial reconfiguration region based on a first subclass definition of the one or more subclass definitions, and load a second persona into the partial reconfiguration region based on a second subclass definition of the one or more subclass definitions, wherein the first persona and the second persona comprise different local attributes and different local methods.
EXAMPLE EMBODIMENT 3. The data processing system of example embodiment 1, wherein the configuration comprises configuration data for each of the one or more subclass definitions, wherein each of the one or more subclass definitions corresponds to a respective persona comprising a logic function to be implemented in the partial reconfiguration region.
EXAMPLE EMBODIMENT 4. The data processing system of example embodiment 1, wherein the partial reconfiguration controller IP is configured to invoke a freeze method to pause outputs from the partial reconfiguration region, load the persona corresponding to the assigned subclass definition into the partial reconfiguration region, and release the freeze method after the persona is loaded.
EXAMPLE EMBODIMENT 5. The data processing system of example embodiment 1, wherein the instructions cause the processing circuitry to generate a design partition based on the base class definition and the one or more subclass definitions, wherein the design partition separates a static region of the programmable logic device from the partial reconfiguration region.
EXAMPLE EMBODIMENT 6. The data processing system of example embodiment 1, wherein the partial reconfiguration interface specifies one or more ports of the partial reconfiguration region that are shared by each of the one or more subclass definitions.
EXAMPLE EMBODIMENT 7. The data processing system of example embodiment 1, wherein the instructions cause the processing circuitry to simulate a behavior of the HDL code to verify a dynamic reconfiguration of the partial reconfiguration region without instantiating wrapper modules or modifying a testbench.
EXAMPLE EMBODIMENT 8. The data processing system of example embodiment 1, wherein the instructions cause the processing circuitry to program the programmable logic device with the configuration, wherein the programmable logic device comprises a field programmable gate array (FPGA).
EXAMPLE EMBODIMENT 9. A non-transitory, computer-readable medium, comprising computer-readable instructions that, when executed by a data processing system, cause the data processing system to:
receive hardware description language (HDL) comprising a definition of a base class and one or more subclasses that extend the base class, wherein the base class specifies a partial reconfiguration region of a programmable logic device; and
configure the programmable logic device to dynamically implement the one or more subclasses in the partial reconfiguration region of the programmable logic device.
EXAMPLE EMBODIMENT 10. The non-transitory, computer readable medium of example embodiment 9, wherein the HDL comprises SystemVerilog dynamic classes.
EXAMPLE EMBODIMENT 11. The non-transitory, computer-readable medium of example embodiment 9, wherein configuring the programmable logic device comprises instantiating a hardware block comprising partial reconfiguration intellectual property (IP).
EXAMPLE EMBODIMENT 12. The non-transitory, computer-readable medium of example embodiment 11, wherein the instructions further cause the data processing system to:
identify an instantiation of the base class in a module of the HDL;
identify an assignment of at least one of the one or more subclasses to a base class variable in the module; and
program the partial reconfiguration IP to dynamically implement a logic function of the at least one assigned subclass at runtime.
EXAMPLE EMBODIMENT 13. The non-transitory, computer-readable medium of example embodiment 9, wherein the base class specifies a partial reconfiguration interface defining input and output ports for the partial reconfiguration region, and wherein the partial reconfiguration interface is shared by each of the one or more subclasses that extend the base class.
EXAMPLE EMBODIMENT 14. The non-transitory, computer-readable medium of example embodiment 9, wherein the base class comprises at least one common attribute and at least one common method shared by each of the subclasses that extend the base class.
EXAMPLE EMBODIMENT 15. The non-transitory, computer-readable medium of example embodiment 14, wherein the at least one common method comprises a freeze method that drives interface outputs of the partial reconfiguration region to a known value during dynamic reconfiguration.
EXAMPLE EMBODIMENT 16. The non-transitory, computer-readable medium of example embodiment 9, wherein the one or more subclasses comprise multiple levels of inheritance, wherein a first subclass extends the base class and a second subclass extends the first subclass.
EXAMPLE EMBODIMENT 17. A method comprising:
receiving, at a data processing system, a system design for a programmable logic device, wherein the system design comprises a plurality of classes associated with dynamically reconfiguring a partial reconfiguration region of the programmable logic device;
parsing, by the data processing system, the system design to:
   identify a definition of at least one base class and a definition of at least one subclass, wherein the subclass is an extension of the base class; and
   identify an assignment of the at least one subclass to an instantiation of the at least one base class; and
generating, by the data processing system, a configuration to provide to the programmable logic device, wherein the configuration comprises a partial reconfiguration intellectual property (IP) block that supports dynamic reconfiguration of the partial reconfiguration region to implement logic associated with the at least one subclass.
EXAMPLE EMBODIMENT 18. The method of example embodiment 17, wherein the base class comprises at least one common attribute and at least one common method, and wherein the at least one subclass comprises at least one local attribute and at least one local method.
EXAMPLE EMBODIMENT 19. The method of example embodiment 18, wherein the at least one common method comprises a freeze method to cause the partial reconfiguration region to pause outputs during dynamic reconfiguration.
EXAMPLE EMBODIMENT 20. The method of example embodiment 17, wherein identifying the definition of the at least one base class comprises defining the partial reconfiguration region with a base class interface as a bounding box, and wherein identifying the instantiation of the at least one base class comprises generating a virtual partial reconfiguration region assigned to the at least one base class.

What is claimed is:

1. A data processing system comprising:
processing circuitry; and
a non-transitory, computer-readable medium, comprising computer-readable instructions that, when executed by the processing circuitry, cause the processing circuitry to:
receive hardware description language (HDL) code comprising a definition of a base class and one or more definitions for one or more subclasses that extend the base class, wherein the base class specifies a partial reconfiguration interface for a partial reconfiguration region of a programmable logic device;
parse the HDL code to identify a declaration of the base class and an assignment of a subclass definition to the declared base class; and
generate a configuration for the programmable logic device, wherein the configuration comprises partial reconfiguration controller intellectual property (IP) configured to load a persona corresponding to the assigned subclass definition into the partial reconfiguration region.

2. The data processing system of claim 1, wherein the partial reconfiguration controller IP is configured to load a first persona into the partial reconfiguration region based on a first subclass definition of the one or more subclass definitions, and load a second persona into the partial reconfiguration region based on a second subclass definition of the one or more subclass definitions, wherein the first persona and the second persona comprise different local attributes and different local methods.

3. The data processing system of claim 1, wherein the configuration comprises configuration data for each of the one or more subclass definitions, wherein each of the one or more subclass definitions corresponds to a respective persona comprising a logic function to be implemented in the partial reconfiguration region.

4. The data processing system of claim 1, wherein the partial reconfiguration controller IP is configured to invoke a freeze method to pause outputs from the partial reconfiguration region, load the persona corresponding to the assigned subclass definition into the partial reconfiguration region, and release the freeze method after the persona is loaded.

5. The data processing system of claim 1, wherein the instructions cause the processing circuitry to generate a design partition based on the base class definition and the one or more subclass definitions, wherein the design partition separates a static region of the programmable logic device from the partial reconfiguration region.

6. The data processing system of claim 1, wherein the partial reconfiguration interface specifies one or more ports of the partial reconfiguration region that are shared by each of the one or more subclass definitions.

7. The data processing system of claim 1, wherein the instructions cause the processing circuitry to simulate a behavior of the HDL code to verify a dynamic reconfiguration of the partial reconfiguration region without instantiating wrapper modules or modifying a testbench.

8. The data processing system of claim 1, wherein the instructions cause the processing circuitry to program the programmable logic device with the configuration, wherein the programmable logic device comprises a field programmable gate array (FPGA).

9. A non-transitory, computer-readable medium, comprising computer-readable instructions that, when executed by a data processing system, cause the data processing system to:
receive hardware description language (HDL) comprising a definition of a base class and one or more subclasses that extend the base class, wherein the base class specifies a partial reconfiguration region of a programmable logic device; and
configure the programmable logic device to dynamically implement the one or more subclasses in the partial reconfiguration region of the programmable logic device.

10. The non-transitory, computer readable medium of claim 9, wherein the HDL comprises SystemVerilog dynamic classes.

11. The non-transitory, computer-readable medium of claim 9, wherein configuring the programmable logic device comprises instantiating a hardware block comprising partial reconfiguration intellectual property (IP).

12. The non-transitory, computer-readable medium of claim 11, wherein the instructions further cause the data processing system to:
identify an instantiation of the base class in a module of the HDL;
identify an assignment of at least one of the one or more subclasses to a base class variable in the module; and
program the partial reconfiguration IP to dynamically implement a logic function of the at least one assigned subclass at runtime.

13. The non-transitory, computer-readable medium of claim 9, wherein the base class specifies a partial reconfiguration interface defining input and output ports for the partial reconfiguration region, and wherein the partial reconfiguration interface is shared by each of the one or more subclasses that extend the base class.

14. The non-transitory, computer-readable medium of claim 9, wherein the base class comprises at least one common attribute and at least one common method shared by each of the subclasses that extend the base class.

15. The non-transitory, computer-readable medium of claim 14, wherein the at least one common method comprises a freeze method that drives interface outputs of the partial reconfiguration region to a known value during dynamic reconfiguration.

16. The non-transitory, computer-readable medium of claim 9, wherein the one or more subclasses comprise multiple levels of inheritance, wherein a first subclass extends the base class and a second subclass extends the first subclass.

17. A method comprising:
receiving, at a data processing system, a system design for a programmable logic device, wherein the system design comprises a plurality of classes associated with dynamically reconfiguring a partial reconfiguration region of the programmable logic device;
parsing, by the data processing system, the system design to:
identify a definition of at least one base class and a definition of at least one subclass, wherein the subclass is an extension of the base class; and
identify an assignment of the at least one subclass to an instantiation of the at least one base class; and
generating, by the data processing system, a configuration to provide to the programmable logic device, wherein the configuration comprises a partial reconfiguration intellectual property (IP) block that supports dynamic reconfiguration of the partial reconfiguration region to implement logic associated with the at least one subclass.

18. The method of claim 17, wherein the base class comprises at least one common attribute and at least one common method, and wherein the at least one subclass comprises at least one local attribute and at least one local method.

19. The method of claim 18, wherein the at least one common method comprises a freeze method to cause the partial reconfiguration region to pause outputs during dynamic reconfiguration.

20. The method of claim 17, wherein identifying the definition of the at least one base class comprises defining the partial reconfiguration region with a base class interface as a bounding box, and wherein identifying the instantiation of the at least one base class comprises generating a virtual partial reconfiguration region assigned to the at least one base class.
